(19) United States
(12) Patent Application Publication
(10) Pub. No.: US 2018/0093751 A1
(43) Pub. Date: Apr. 5, 2018

(54) System for reducing thermal barrier of hypersonic aero vehicle

(71) Applicant: Zhongwei Shi, Shanghai (CN)

(72) Inventor: Zhongwei Shi, Shanghai (CN)

(21) Appl. No.: 15/831,244

(22) Filed: Dec. 4, 2017

(51) Int. Cl. B64C 1/00; B64C 23/02

(52) U.S. Cl. CPC B64C 1/0009; B64C 2230/00; B64C 23/02

(57) ABSTRACT

A system for reducing thermal barrier of hypersonic aero vehicle is disclosed, wherein the obelisk shaped hypersonic aero vehicle is covered by combined multiple long and narrow plates. Across the plates, roller bearings are placed and spaced in short distance. The air frictions across the roller bearings of the hypersonic aero vehicle consecutively and the coefficient of friction is 0.002. The heat of the air friction is just normal and does not cause the thermal barrier and melting. The system improves the speed and reduces the energy consumption significantly.

The advantages of the system are: 1. reducing the thermal barrier with innovative structure; 2. solving the problem of thermal barrier which is common for conventional hypersonic aero vehicle.

### BACKGROUND OF THE PRESENT INVENTION

### Field of Invention

The present invention relates to a system for reducing a thermal barrier of a hypersonic aero vehicle by changing the shape of the hypersonic aero vehicle and covering the hypersonic aero vehicle with roller bearings, and more particularly to space technology.

### Description of Related Arts

When a rocket or a supersonic aircraft slides in the air, intense friction is between the surface and the air. The higher the speed is, the more rapidly heat rises, which threats an astronaut and equipments. Based on calculation, the friction temperature reaches 200° C. when a cruising speed is Ma 2.5 which is 20 times of the sound; the friction temperature reaches 1300° C. when the cruising speed is Ma 6; the temperature rises sharply to 13560° C. when the cruising speed is Ma 20, which exceeds the surface temperature of the sun (6000° C.) by one time.

The changeable coefficient of kinetic friction between the soft air and the hard material of the surface of the hypersonic aero vehicle, which is caused by a shear failure of the hard surface of hypersonic aero vehicle and the cohension of air, increases with the speed. The higher the speed is, the larger the coefficient of kinetic friction. A spread oscillating friction is generated when the coefficient of kinetic friction is extremely high, such as the speed of a propeller is around Ma 0.8 but the speed of the propeller may reach sound speed while diving, which causes violent body oscillation and enormous noise or even induce a propeller crash. The oscillating fraction is dangerous in the situation.

Conventionally, the worldwide aeronautical circle solves the problem of thermal barrier in a superficial way by adopting heat-resistant polymer coating, titanium alloys, stainless steels and etc. for producing machine elements, and nanometer materials, or applying flammable material on the surface of the aircraft to take away part of the heat. Although the solutions have advantages, an efficient and cost-saving method is required which is able to be obtained by thinking out of the box.

The sliding friction is able to be converted to rolling friction by adopting ball bearings the coefficient of friction of which is between 0.002-0.005. The coefficient of friction of ball bearings does not change with the increasing speed. The coefficient of friction of moving a car without wheels is above 5-6, which is 0.5 with wheels. The square of the speed of sliding friction is proportional to the heat increase. The temperature of the surface of the aircraft is 13500° C. when the speed reaches Ma 20. The temperature of the surface of the aircraft is 13500° C.*0.002=27° C. if the aircraft surface is covered with roller bearing. To reduce the thermal barrier by convert the sliding friction to rolling friction is able to speedup the aircraft by thousands of times due to the reduction of friction, which enable the invention of flying machine such as UFO. A small rocket manufactured by adopting the concept is able to perform intercontinental attack.

The conventional technology stick to heat-resistant material and ignores the possibility of converting the sliding friction to rolling friction due to the rocket and supersonic aircraft are normally shaped in column with a curved surface. Placing roller bearings on the curved surface is impossible for the conventional technology.

### SUMMARY OF THE PRESENT INVENTION

An object of the present invention is to provide a system for reducing the friction significantly and improve the speed of the aircraft while reducing the energy consumption.

Accordingly, in order to accomplish the above objects, the present invention changes the shape of the rocket and supersonic aircraft into an obelisk with multiple geometric flats on which the combined multiple plates with roller bearings are covered, wherein the sliding friction between the air and the surface of the aircraft is converted to rolling friction.

### BRIEF DESCRIPTION OF THE DRAWINGS

FIG. 1 is a perspective view of an outlook of a head in a regular pyramid shape and a body in a cuboid shape of an intercontinental rocket (a cross section is in a rectangular shape);

FIG. 2 is a side view of a long and narrow plate with roller bearings and a perspective view of streamlines across a surface of the roller bearings;

FIG. 3 is a top view of the long and narrow plate with roller bearings from right above.

Element numbers: 1. head of a rocket in a regular pyramid shape; 2. side view of a body of the rocket in a cuboid shape; 3. long and narrow plate; 4. roller bearing; 5. bearing; 6 roller bearing; 7. bottom of the plate; 8. up edge of the plate; 9. streamline across above the roller bearings; 10. airstream suction above from the bottom of the plate; 11. axis rod.

### DETAILED DESCRIPTION OF THE PREFERRED EMBODIMENT

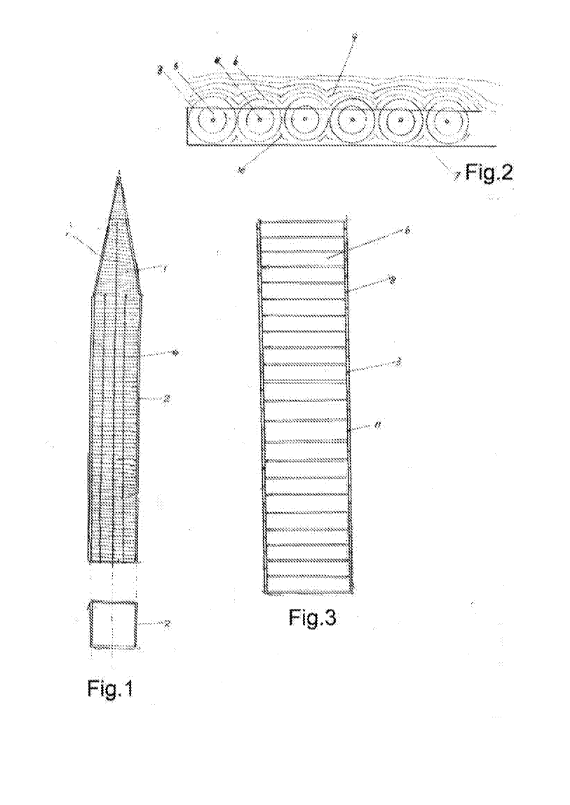

Referring to FIG. 1 of the drawings, according to a preferred embodiment of the present invention is illustrated, wherein a head of the rocket is in a regular pyramid shape, an included angle of which is less than 20° . Combined multiple narrow and long plates are covered on a flat a side view of which is a rectangle on a body of the rocket. Multiple roller bearings 4 are arranged across each of the long and narrow plates. Inside the roller bearings 4 is a hollow tube inside which bearings 5 are embedded; wherein an axis rod 11 extends across the bearings; two ends of the axis rod are fixed below the upper edges 8 of two sides of the long and narrow plates. The streamline of the high-speed rotating roller bearing (the coefficient of friction is 0.002) runs across the roller bearings with a flow speed of the layer as an upper part in the typical Karman Vortex Artier picture, which dose not sink below the roller bearing while the air flow of the bottom of the plate is static. The pressure of the air flow of the bottom of the plate is much higher than the high speed air flow on the top. Based on Bemoueeo theorem, the air flow of the bottom of the plate is suctioned and taken away by the air flow on the top and a rough vacuum is formed. The rough vacuum guarantees an undisturbed clockwise rotation of the roller bearings. When the speed of the rocket is higher than Ma 20 the temperature of the surface of the rocket is around 27° C. due to the coefficient of friction of the bearing is 0.002. Sliding friction still exist at the edges of the plate, which accounts for around 3% percent of the whole area. The heat generated by the sliding friction is conducted to the surface of the roller bearing and dispersed to the air according to the thermal conductivity of the metal. The temperature is reduced, the energy consumption is saved and the speed is increased.

Long distance launch may adopts another invention Propulsion enhancement arrangement for rocket (U.S. Pat. No. 7,814,835B2) which is able to assist the launch speed to reach Ma 40.

The present invention requires no complex techniques other than firmly fixation with high accuracy. The production cost is low and the techniques required are simple. The production is able to be carried out in medium factories.

What is claimed is:

1. A system for reducing a thermal barrier of a hypersonic aero vehicle, comprising an obelisk shaped hypersonic aero vehicle (a rocket or a supersonic aircraft), combined multiple long and narrow plates which cover the obelisk shaped hypersonic aero vehicle, multiple roller bearings which are arranged across the multiple long and narrow plates and are spaced in a short distance.

2. The system, as recited in claim 1, wherein an included angle of a head of the hypersonic aero vehicle is less than 20°.

3. The system, as recited in claim 1, wherein inside the roller bearings is a hollow tube inside which bearings are embedded on a left, a middle and a right; an axis rod extends across the bearings; two ends of the axis rod are fixed on upper edges of two sides of the long and narrow plates.
